(19) United States
(12) Patent Application Publication
(10) Pub. No.: US 2006/0042152 A1
(43) Pub. Date: Mar. 2, 2006

(54) Tool kit for fishing

(76) Inventor: Randolph A. Pearson, Carney, MI (US)

Correspondence Address: LITMAN LAW OFFICES, LTD, PO BOX 15035, CRYSTAL CITY STATION, ARLINGTON, VA, 22215, US

(21) Appl. No.: 11/190,815

(22) Filed: Jul. 28, 2005

Related U.S. Application Data
(60) Provisional application No. 60/604,839, filed on Aug. 27, 2004.

(51) Int. Cl. A01K 97/06

(52) U.S. Cl. 43/54.1

(57) ABSTRACT

A tool kit for fishing is a multi-compartment case for use by fishermen. The case has a separate compartment for each of a plurality of tools. For example, in one embodiment the tool kit includes one each of long nose pliers, bolt cutters, fish mouth spreaders, and scissors for removing hooks from a captured fish, although the number and type of tools may vary. Each tool is separately tethered to the case by a lanyard to prevent loss of the tool. In some embodiments, the case has floatation material to provide buoyancy in order to prevent loss of the entire case of tools. The case may have a single lid closing over all the separate compartments, or the lid may be divided into individual closures for each compartment, the latter providing separate, relatively watertight compartments to improve buoyancy when only one tool is being used.

### CROSS-REFERENCE TO RELATED APPLICATION

This application claims the benefit of U.S. Provisional Patent Application Ser. No. 60/604,839, filed Aug. 27, 2004.

### BACKGROUND OF THE INVENTION

1. Field of the Invention

The present invention relates to tool kits. More particularly, the present invention relates to a tool kit useful for fisherman for removing hooks from fish.

2. Description of the Related Art

It is common for a fisherman to use gripping, cutting, and fish mouth opening tools during the removal of hooks from a fish. Such tools are particularly useful when the fisherman intends to release the fish, as minimal injury to the captured fish is key to its survival. Such tools are easily lost overboard, as the fisherman tends to lean out of the boat during the removal of tackle and release of the fish. Also, a fisherman may easily drop and lose such tools in a similar manner when wading. It would be desirable to provide a kit having a multi-chambered container for convenient carrying of a variety of such tools. It would also be desirable that the individual tools be tethered to the kit by lanyards or the like to minimize the likelihood of loss of an individual tool. It would also be desirable that the container for the kit be buoyant so that the kit will float if accidentally dropped overboard during fishing from a boat or if the kit is tied to the clothing of a wading fisherman, thereby avoiding loss of the tools and remaining conveniently available for use, but not requiring carrying during fishing.

U.S. Pat. No. 2,811,276, issued Oct. 29, 1957, to Ray, describes a tackle box having multiple compartments and providing for buoyancy, for avoiding loss of the tackle box, and for acting as a lifesaver in emergencies. U.S. Pat. No. 4,829,699, issued May 16, 1989, to Perkings, describes floating tackle box having multiple compartments.

U.S. Pat. No. 5,092,074, issued Mar. 3, 1992, to Zincke, describes a fish mouth spreader tool having a lanyard for securing to the fisherman's person and teaching the use of floatation material in its construction.

U.S. Pat. No. 6,014,833, issued Jan. 18, 2000, to Benavidez, describes a fisherman's floating storage device for wading fishermen. The device is made from polystyrene and has a large central opening for supporting a five-gallon bait pail. The device has compartments for storing beverages, drinking cups, and other conveniences. The device has a built-in tackle box with multiple compartments and a lid for the tackle box that is tethered to the device.

None of the above inventions and patents, taken either singly or in combination, is seen to describe the instant invention as claimed. Thus, a tool kit for fishing solving the aforementioned problems is desired.

### SUMMARY OF THE INVENTION

The tool kit for fishing is a multi-compartment case for use by fishermen. The case has a separate compartment for each of a plurality of tools. For example, in one embodiment the tool kit includes one each of long nose pliers, bolt cutters, fish mouth spreaders, and scissors for removing hooks from a captured fish, although the number and type of tools may vary. Each tool is separately tethered to the case by a lanyard to prevent loss of the tool. In some embodiments, the case has floatation material to provide buoyancy in order to prevent loss of the entire case of tools. The case may have a single lid closing over all the separate compartments, or the lid may be divided into individual closures for each compartment, the latter providing separate relatively watertight compartments so as to improve buoyancy when only one tool is being used.

These and other features of the present invention will become readily apparent upon further review of the following specification and drawings.

### BRIEF DESCRIPTION OF THE DRAWINGS

FIG. 1 is an environmental, perspective view of a tool kit for fishing according to the present invention.

FIG. 2 is a front section view of the tool kit of FIG. 1.

FIG. 3 is a perspective view of the tool kit of FIG. 1 with the lid open.

FIG. 4 is a perspective view of another embodiment of the invention having separate lids for each compartment.

FIG. 5 is a partially exploded view of the tool kit of FIG. 4.

Similar reference characters denote corresponding features consistently throughout the attached drawings.

### DETAILED DESCRIPTION OF THE PREFERRED EMBODIMENTS

The present invention is a tool kit for fishermen having multiple compartments and a selection of tools commonly used by fishermen.

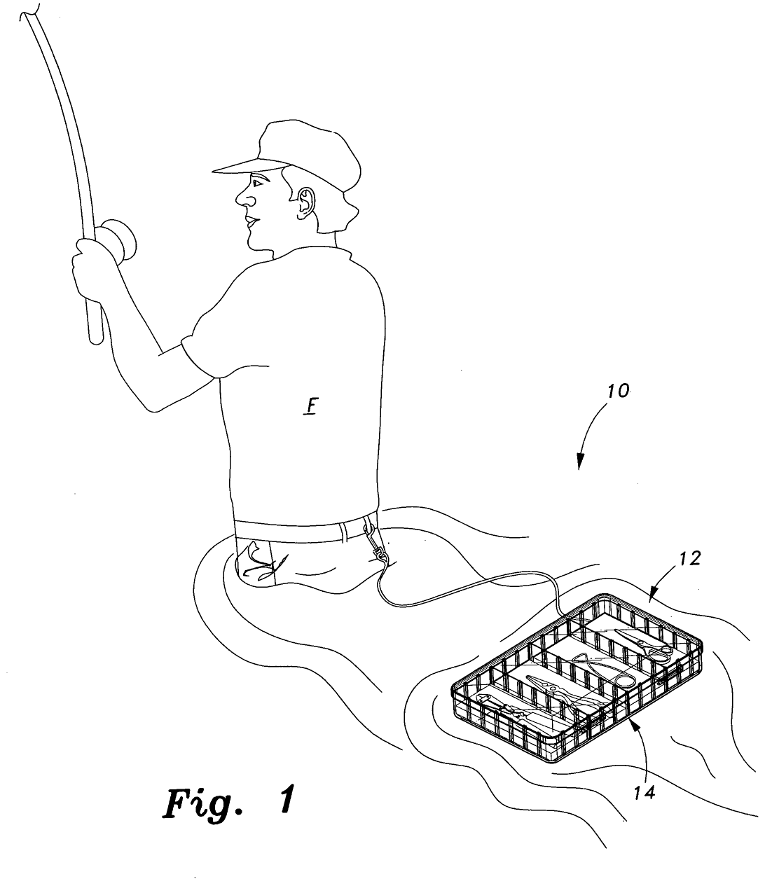

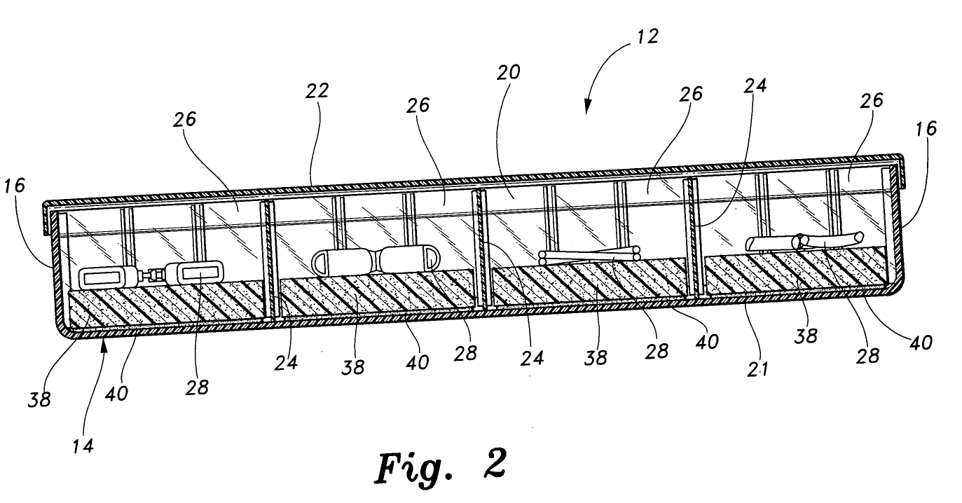

Referring to FIGS. 1-3, there is shown an environmental perspective view, a front section view, and a perspective view, respectively, of an embodiment of a fisherman's tool kit, referred to generally as 10 in the drawings. FIG. 1 shows a kit 10 tethered to the waist of a wading fisherman F by a flexible cord and a snap hook. However, it will be understood that the tether and snap hook are not essential elements of the invention, and that the kit 10 is equally appropriate for use by a fisherman in a boat without the necessity for a tether attaching the kit 10 to the boat.

Tool kit 10 includes a selection of tools 12 housed in a multi-compartment container 14. Container 14 is preferably made of transparent plastic material in order to reveal the tools held individually in each compartment. The container 14 has sidewalls 16, a front wall 18, a rear wall 20 and a bottom wall 21, and has a hinged lid 22 allowing the opening and closing off the compartmented container 14 for access to the desired tools.

Container 14 has compartment inner walls 24 spaced from and parallel to sidewalls 16, and hinged lid 22 is attached to rear wall 20 by lid hinge 46, although a hinge 46 is not essential to the invention. The compartments 26 formed by the respective walls and lid each contain a tool 28. As shown, the plurality of tools 12 includes pairs of long-nose pliers, bolt cutters, fish mouth spreaders, and scissors are contained in separate respective compartments 26. Such an assortment is useful for removing a hook from a captured fish, the pliers gripping the hook, the bolt cutter cutting the hook, the fish mouth spreaders holding the fish's mouth open while removing the hook, and the scissors cutting the fishing line. It will be understood, however, that the kit 10 may include additional special purpose tools, such as a compass, signaling device, etc., or a different assortment of special purpose tools for the fisherman.

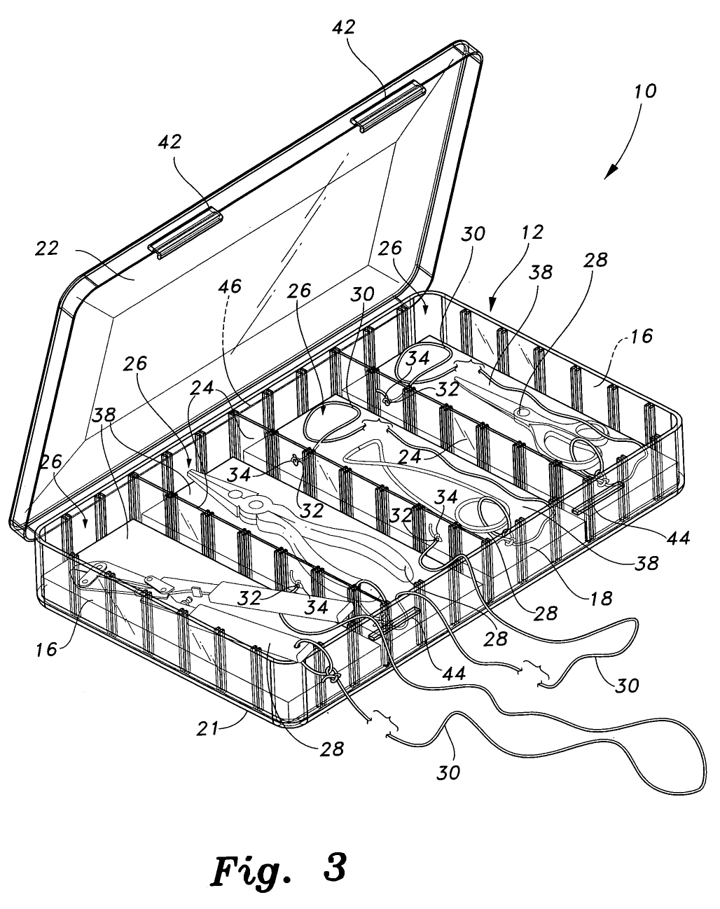

In some embodiments, the container 14 may be equipped with floatation material to prevent loss of the container 14 with its entire plurality of tools 12 should the container be accidentally lost overboard. As best seen in FIG. 3, floatation material such as polystyrene foam, such as Styrofoam® or cork, is cut to form floatation layers 38 and attached by adhesive 40 to the bottom wall 21 shared by each compartment 26, providing buoyancy to the container 14, even when capsized with hinged lid 22 open.

In some embodiments, the plurality of tools 12 may be tethered to the container 14 to prevent loss of the tools. As seen in FIG. 3, individual lanyards 30 are attached to respective tools 28 and anchored within their corresponding respective compartments 26. Lanyards 30 are shown attached to inner walls 24 through anchor bores 32 and anchor knots 34. Each tool 28 has a lanyard attachment, such as a knotted loop, as shown. The lid 22 of container 14 has snap latches depending from the front edge of lid 22 and removably snapping, due to the resiliency of the plastic material, over latch receivers 44 protruding outward from the front surface of front wall 18. The container 14 provides a waterproof housing for the tools 28.

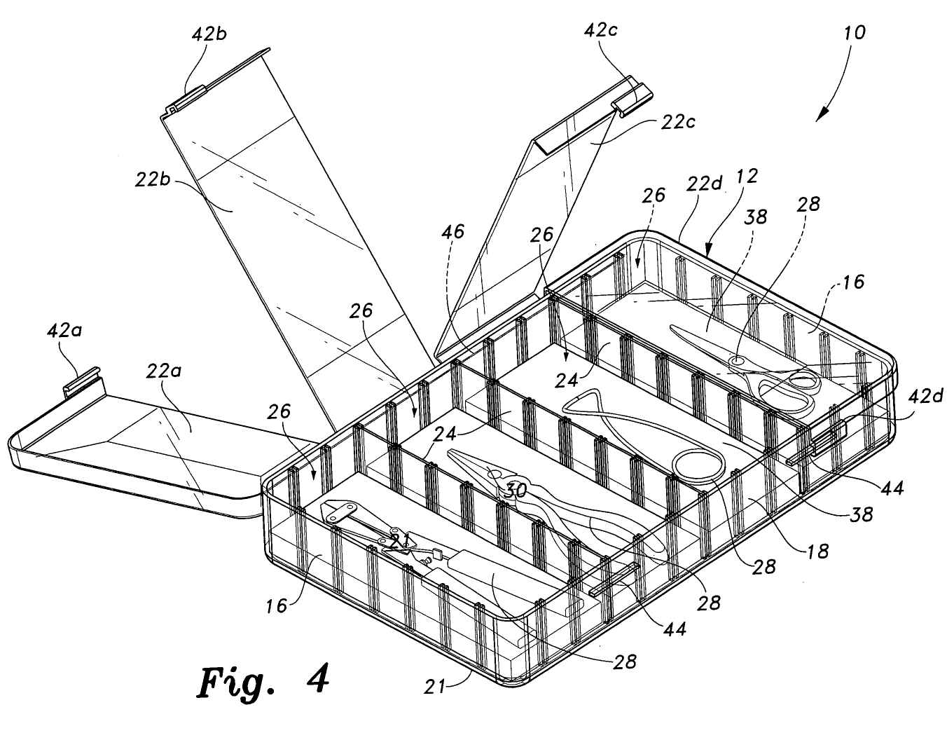

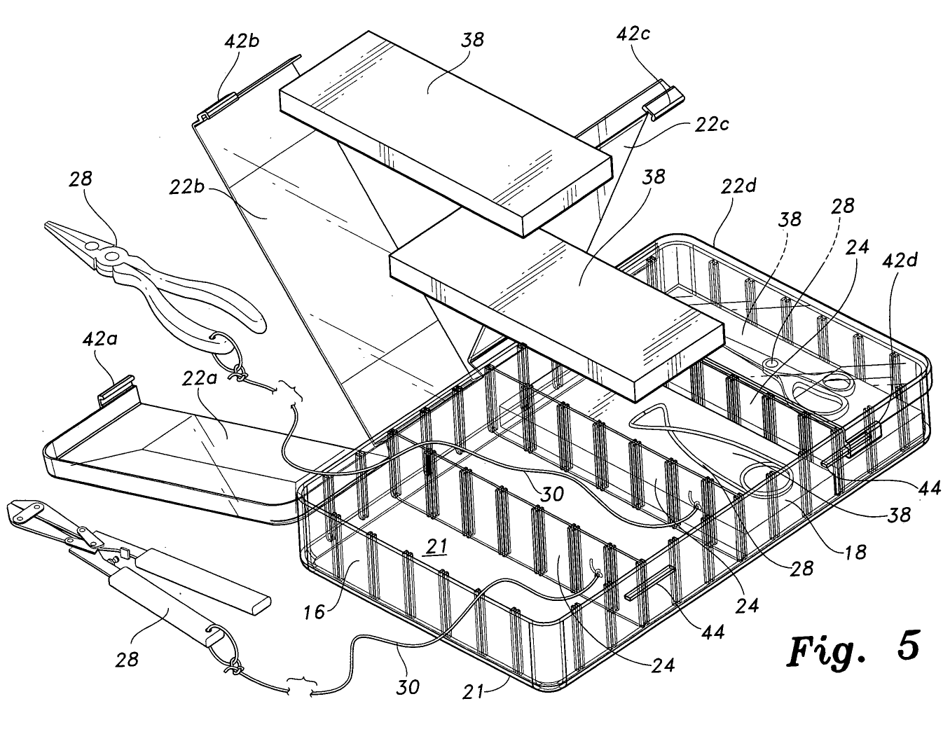

Referring to FIGS. 4 and 5, there are shown a perspective and a partially exploded view of another embodiment of the fisherman's tool kit. All components of the kit in FIGS. 4 and 5 are the same as the components shown in FIGS. 1-3, except for the container lid. The kit shown in FIGS. 4 and has separate lids 22a, 22b, 22c, and 22d corresponding to each of the individual compartments 26. As seen, lids 22a, 22b, 22c, and 22d may be split from container-hinged lid 22 of the embodiment of FIGS. 1-3. Lids 22a, 22b, 22c, and 22d are shown with respective snap latches 42a, 42b, 42c, and 42d, respectively and, as shown, may be split from snap latches 42 of the embodiment of FIGS. 1-3. This embodiment allows access to a particular tool 28 while leaving the remaining tools encased in their respective compartments 26. This embodiment also provides for added buoyancy from the remaining closed compartments 26 if the kit 12 is dropped overboard and protects the tools from immersion in the water. As in FIG. 3, lanyards 30 are attached to each individual tool 28, as by the knotted loops as shown, and are anchored in the respective compartments 26 through lanyard anchor bores through compartment inner walls 24 and anchored by knots 34.

In use, a fisherman F, upon making a catch, opens the lid or appropriate lids and employs a fish mouth opener and a pair of long-nose pliers as shown to remove the hook from the mouth of the fish. If this is not an option, the bolt cutter may be used to cut the hook off, or the scissors used to cut the line, leaving the hook in the fish. Upon completion of the selected task, the fisherman F returns the tools to their respective compartments and closes the lid or lids.

It is to be understood that the present invention is not limited to the embodiments described above, but encompasses any and all embodiments within the scope of the following claims.

1. A tool kit for fishing comprising:
a container having a plurality of compartments defined therein:
at least one lid disposed over said plurality of compartments and forming a watertight seal over said compartments;
a fishing tool disposed in each of said compartments; and
a lanyard tethering each said fishing tool to its respective compartment.

2. The tool kit of claim 1, said container having a front wall, said at least one lid having a hinge connected to said rear wall and said at least one lid having a latch for latching connection to said front wall.

3. The tool kit of claim 1, each said compartment being defined by walls, at least one of said walls having floatation material adhered to an inner side thereof.

4. The tool kit of claim 2, each said compartment being defined by walls, at least one of said walls having floatation material adhered to an inner side thereof.

5. The tool kit of claim 4, further comprising a tether attached to and extending therefrom for attachment to the clothing of a fisherman.

6. The tool kit of claim 4, wherein said tool kit is buoyant in water when said compartments are open and filled with water.

7. The tool kit of claim 4, wherein said tool kit container is made of transparent material.

8. A tool kit for fishing comprising:
a multi-compartment container having a front wall, a rear wall, opposed sidewalls, and a bottom wall, a lid connected to said rear wall, and a plurality of inner walls spaced from and parallel to said opposed sidewalls and forming, along with said front wall, said rear wall, and said bottom wall, a plurality of compartments;
a floatation layer disposed along and adhered to each bottom wall within each said compartment;
a fishing tool removably disposed in each said compartment; and a corresponding lanyard anchored to an inner wall corresponding to each said fishing tool and tethering said tool to said compartment in which it is disposed.

9. The tool kit of claim 8, said container having a hinge connecting said lid with said rear wall.

10. The tool kit of claim 9, said front wall having a latch receiver, said lid having a latch releasably connected with said latch receiver.

11. The tool kit of claim 10, further comprising a tether attached to and extending therefrom for attachment to the clothing of a fisherman.

12. A tool kit for fishing, comprising:
a multi-compartment container having a front wall, a rear wall, opposed sidewalls, and a bottom wall, and having a plurality of inner walls spaced from and parallel to said opposed sidewalls and forming, along with said front wall, said rear wall, and said bottom wall, a plurality of compartments;
an individual compartment lid disposed over a respective one of each of said compartments;
a floatation layer disposed along and adhered to said bottom wall of each said compartment;
a fishing tool disposed in each said compartment; and
a corresponding lanyard attached to each said fishing tool and tethering said tool to said compartment in which it is disposed.

13. The tool kit of claim 12, each said individual compartment lid having a hinge attached to said rear wall and each said individual compartment lid having a latch, said front wall having a latch receiver for releasably receiving said compartment lid latch.

14. The tool kit of claim 13, further comprising a tether attached to and extending therefrom for attachment to the clothing of a fisherman.

15. The tool kit of claim 12, wherein said multi-compartment container is constructed of transparent material.

16. The tool kit of claim 15, wherein said tool kit is buoyant in water when said compartments are open and filled with water.

17. The tool kit of claim 13, said container comprising four compartments, said tool kit comprising individual tools comprising pairs of long-nose pliers, bolt cutters, fish mouth spreaders, and scissors, each of which is connected to an individual said lanyard and fitting within a respective said compartment.

18. The tool kit of claim 17, said container front wall having two spaced latch receivers and pairs of adjacent individual compartment lids having split latches fore releasable attachment to one of said two spaced latch receivers.

19. The tool kit of claim 17, each of said lanyards being anchored to a respective said inner wall of said container.
